(19) United States
(12) Patent Application Publication
(10) Pub. No.: US 2013/0238371 A1
(43) Pub. Date: Sep. 12, 2013

(54) SELF-SERVICE APPARATUS FOR HOTEL ROOM SELECTION AND CHECK-IN

(71) Applicant: Tuming You, Xiamen (CN)

(72) Inventor: Tuming You, Xiamen (CN)

(21) Appl. No.: 13/418,036

(22) Filed: Mar. 12, 2012

(51) Int. Cl. G06Q 10/02

(52) U.S. Cl. 705/5

(57) ABSTRACT

An apparatus for hotel room selection and check in includes a database, user interface, room key dispenser, and computer processor. The apparatus stores and displays images and descriptions of a hotel or parts of a hotel to help a person make a room selection. The apparatus includes a touch screen on which touch-sensitive graphical buttons are displayed to allow a person to set selection criteria, which are used by the processor as filter parameters. The filter parameters are applied, by the apparatus or an external system, to a hotel room data set to obtain information about one or more hotel rooms that meet the person's selection criteria.

### FIELD OF THE INVENTION

This invention relates generally to electronic devices having a touch-sensitive screen as a user interface and, more particularly, a self-service apparatus for hotel room check-in.

### BACKGROUND OF THE INVENTION

With the advent of automated teller machines (ATM) and systems for making purchases via Internet websites, consumers have become accustomed to making transactions without the aid of a person on the other side of a counter or service desk. There is now increasing consumer demand for self-service options in the hospitality industry which have traditionally focused on personal contact and service.

What is needed is an apparatus that can provide people a user friendly way to select a hotel room, check-in, pay, and obtain a room key.

### SUMMARY OF THE INVENTION

Briefly and in general terms, the present invention is directed to an apparatus for hotel room selection and check in. In aspects of the invention, the apparatus comprises a database, a user interface including a display screen, a room key dispenser, and at least on computer processor configured to execute instructions stored in database for controlling the user interface and the room key dispenser.

In aspects of the invention, the database stores images and descriptions of a hotel or parts of a hotel, which can be displayed on the user interface.

In aspects of the invention, the database stores instructions executable by the at least one computer processor for setting filter parameters for hotel room selection.

In aspects of the invention, the display screen is a touch screen controlled by the at least one computer processor to display touch-sensitive graphical buttons for setting the filter parameters.

In aspects of the invention, the apparatus comprises a payment device reader. In other aspects, the payment device reader can be controlled by the at least one computer processor to obtain data from a payment device. In other aspects, the at least one computer processor is configured to execute instructions, stored in the database, to transmit the data obtained from the payment device to an external system.

In aspects of the invention, the room key dispenser is configured to store a plurality of room keys. In other aspects, the room key dispenser is configured to activate a room key. In other aspects, the room key dispenser is controlled by the at least one computer processor to obtain a room key serial number from a room key stored within the room key dispenser. In other aspects, the at least one computer processor communicates the room key serial number to an external system. In other aspects, the room key dispenser is controlled by the at least one computer processor to program a code to a room key stored within the room key dispenser. In other aspects, the at least one computer processor obtains the code from an external system.

The features and advantages of the invention will be more readily understood from the following detailed description which should be read in conjunction with the accompanying drawings.

### BRIEF DESCRIPTION OF THE DRAWINGS

FIG. 1 is a block diagram of an exemplary automated system having an apparatus configured to allow a user to select a hotel room, check in, pay, and/or obtain a room key.

FIG. 2 is a block diagram of an exemplary automated system similar to that of FIG. 1.

FIG. 3 is a block diagram of an exemplary tablet computer in an apparatus configured to allow a user to select a hotel room, check in, pay, and/or obtain a room key.

FIG. 4 is a diagram of exemplary software stored in a computer of an apparatus configured to allow a user to select a hotel room, check in, pay, and/or obtain a room key.

FIG. 5 is a table showing exemplary specifications for a tablet computer in an apparatus configured to allow a user to select a hotel room, check in, pay, and/or obtain a room key.

FIG. 6 is a flow diagram showing an exemplary method for selecting a hotel room, checking in, paying, and obtaining room key.

FIG. 7 is screen layout showing an exemplary room selection graphical interface displayed on a touch screen.

FIG. 8 is a screen layout similar to that of FIG. 7, showing an exemplary image of a room meeting selection criteria or filter parameters set by person using the room selection graphical interface.

FIG. 9 is a screen layout showing an exemplary confirmation graphical interface displayed on a touch screen.

### DETAILED DESCRIPTION OF EXEMPLARY EMBODIMENTS

As used herein, the word “hotel” encompasses any lodging establishment having rooms available for stay, including without limitation a motel, inn, hostel, resort, single building, and multiple building complex.

The phrases “touch sensitive display screen,” “touch sensitive screen,” and “touch screen” are used interchangeably herein. With finger taps and movements on the touch screen, users are able to interact with a computer system without a conventional push-button keyboard and mouse input device. As used herein, a “touch screen” is an electronic visual display configured to detect the presence, location, and movement of a physical object within the display area of the touch screen. The physical object can be a finger, a stylus, or other utensil manipulated by a person. Object detection can be performed according to various technologies. Object detection can be accomplished with resistive, acoustic, infrared, near-infrared, vibratory, optical, surface capacitance, projected capacitance, mutual capacitance, and self-capacitance screen technologies. For example, detecting the presence, location, and movement of a physical object within the display area can include sensing a distortion of an electrostatic field of the screen, measurable as a change in capacitance due to physical contact with a finger or other electrical conductor. As a further example, object detection can include sensing disruption of a pattern or grid of electromagnetic beams without any need for actual physical contact with or touching of the display area.

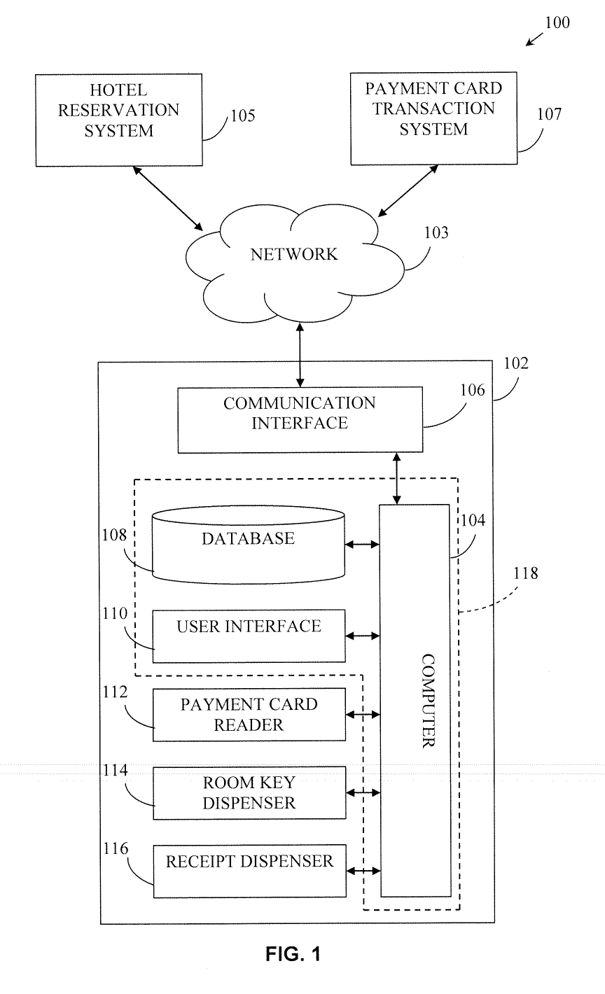

Referring now in more detail to the exemplary drawings for purposes of illustrating embodiments of the invention, wherein like reference numerals designate corresponding or like elements among the several views, there is shown in FIG. 1 an exemplary automated system 100 for selecting a hotel room, checking in, paying, and/or obtaining a room key. Exemplary self-service apparatus 102 helps people to select a room and provides a means for selecting a hotel room, checking in, paying, and obtaining a room key without the direct aid of or personal contact with another person. Apparatus 102 can be located at a hotel or away from a hotel, such as a tourist center, airport, train or subway station, bus terminals, or other location where people need lodging information. Apparatus 102 can be in the form of a kiosk or a stand-alone terminal.

Apparatus 102 is in two-way communication via communications network 103 with hotel reservation system 104 and payment card transaction system 106. Network 103 can include any combination of conventional wire and wireless communication platforms, including but not limited to the Internet, local area networks, wide area networks, telephone networks, cable television networks, and satellite communication networks.

Hotel reservation system 105 is a computerized system used by a hotel or agency to keep track of, manage, record, and make changes to data for room availability, room rates, and other hospitality services. Payment card transaction system 107 is a computerized system used by a financial institution or agency to keep track of, manage, record payments for financial transactions such as payments and credits for a hotel room and other hospitality services.

Hotel reservation system 105 and payment card transaction system 107 are referred to as external systems with which apparatus 102 communicate to perform the functions described below. In other embodiments, apparatus 102 communicates with other external systems when performing the functions described below.

Apparatus 102 includes computer 104 having one or more processors configured to communicate with, operate, control, drive, and/or receive and send data from/to communication interface 106, database 108, user interface 110, payment card reader 112, room key dispenser 114, and receipt dispenser 116. The one or more processors of computer 104 are configured to execute instructions stored in database 108.

Communication interface 106 is configured to send and receive data to/from network 106.

Database 108 includes one or more volatile (transitory) and non-volatile (non-transitory) memory components for storing data. Data stored in volatile and/or non-volatile memory components of database 108 include without limitation images and descriptions of rooms, restaurants, bars, meeting rooms, amenities, and services provide by one or more hotels. Stored data can include information received from hotel reservation system 105, such as room availability, room rates, and electronic codes for room keys. Stored data can further include information received from payment card transaction system 107 and information conventionally used for making electronic payment transactions. Stored data can include instructions, executable by computer 104, for controlling user interface 114, payment card reader 116, room key dispenser 118, and receipt dispenser 120. The instructions can be parts or modules of software application programs stored in volatile and/or non-volatile memory components of in database 108.

User interface 110 includes a touch screen.

Payment card reader 112 includes any one or a variety of devices for receiving and/or transferring data from/to a payment device. Non-limiting examples of a payment device include a credit card, debit card, smart phone, and objects having a computer readable medium, such as a magnetic strip, radio frequency identification (RFID) tag, near field communication (NFC) tag, and/or an electronic chip for making a financial transaction.

Room key dispenser 114 includes a receptacle for holding a plurality of room keys, a device for receiving and/or transferring data from/to a room key, and a device for dispensing a room key from the receptacle. The room key can be a device having a computer readable medium, such as a magnetic strip, radio frequency identification (RFID) tag, near field communication (NFC) tag, and/or an electronic chip storing data that uniquely identifies the room key.

Receipt dispenser 116 includes a device configured to print a record of a transaction, such as a payment or credit for a hotel room and other hospitality services.

Tablet computer 118 can be used in apparatus 102. Computer 104, database 108, and user interface 110 can form integral parts of tablet computer 118.

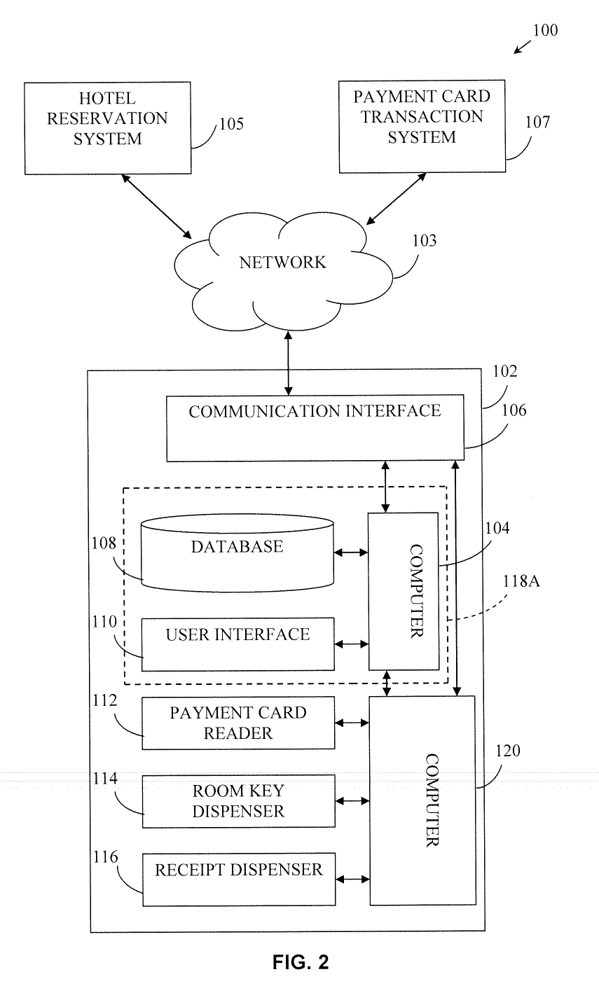

In other embodiments as shown in FIG. 2, a second computer 120 can be used. Second computer 120 includes one or more processors configured to communicate with, operate, control, drive, and/or receive and send data to communication interface 106, payment card reader 112, room key dispenser 114, and receipt dispenser 116. The one or more processors of second computer 120 are configured to execute instructions stored in a non-volatile (non-transitory) memory device coupled to computer 120. It will be appreciated that modifications can be made to the apparatus without departing from the scope of the invention.

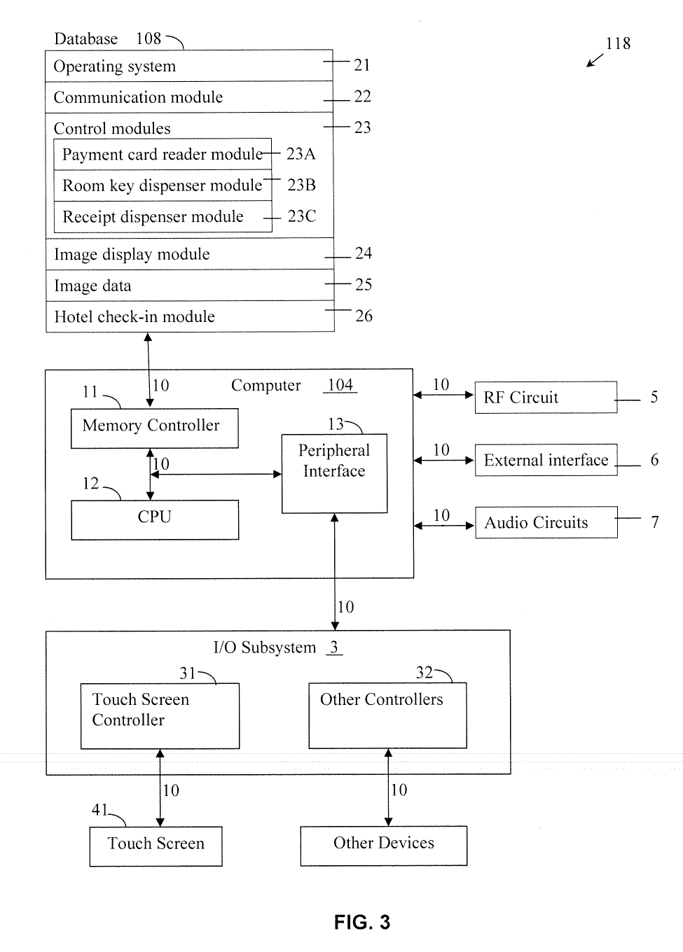

FIG. 3 shows an exemplary configuration for tablet computer 118 of FIG. 1.

Computer 104 includes memory controller 11, processor (CPU) 12, and peripheral interface 13. Database 108 is a single or multiple coupled volatile (transitory) and non-volatile (non-transitory) memory devices/components, including without limitation magnetic disk storage devices, flash memory devices, and other non-volatile solid-state memory. Software programs and image data 25 are stored in database 108. Software programs include operating system 21, communication module 22, control modules 23, image display module 24, and hotel check-in module 26. Control modules 23 include payment card reader module 23A, room key dispenser module 23B, and receipt dispenser module 23C for controlling payment card reader 112, room key dispenser 114, and receipt dispenser 116 (FIGS. 1 and 2). Software programs stored in database 108 may include a hotel reservation system module for interacting with and communicating (transmitting and receiving) data from hotel reservation system 105 (FIGS. 1 and 2), and a payment card transaction system module for interacting with and communicating (transmitting and receiving) data from payment card transaction system 107 (FIGS. 1 and 2).

Input/output (I/O) subsystem 3 includes touch screen controller 31 and other input controller 32 for other devices, such as payment card reader 112, room key dispenser 114, and receipt dispenser 116. Computer 104 is connected to RF circuit 5, external interface 6 and audio circuit 7. External interface 6 can be coupled to or be an integral part of communication interface 106 (FIGS. 1 and 2). Connections through signal bus 10 allow each of the above components to communicate with each other through any combination of a physical electrical connection and a wireless communication connection.

It will be appreciated that modifications can be made to tablet computer 118 without departing from the scope of the invention. For example, in some embodiments, any one or a combination of memory controller 11, processor 12, and peripheral interface 13 can be implemented in a single chip or multiple chips. In some embodiments, some or all of the memory components of database 108 can be implemented on a single chip with any one or a combination of memory controller 11, processor 12, and peripheral interface 13. As a further example, control modules for payment card reader 112, room key dispenser 114, and receipt dispenser 116 can be omitted from tablet computer 118A of FIG. 2 and stored in a non-volatile (non-transitory) memory device coupled to computer 120 (FIG. 2).

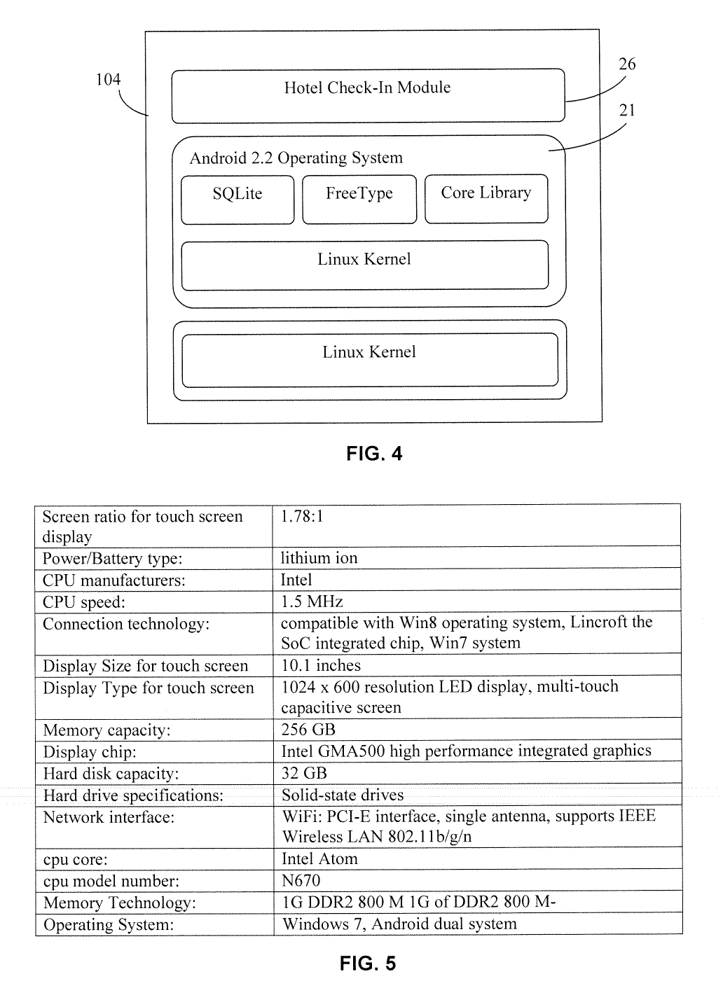

FIG. 4 shows a diagrammatic view of exemplary software stored in computer 104. Computer 104 is equipped with hotel check-in module 26, an Android operating system 21, SQLite relational database management system, and FreeType software library for rendering. FIG. 5 shows exemplary specifications for tablet computer 118, 118A containing computer 104.

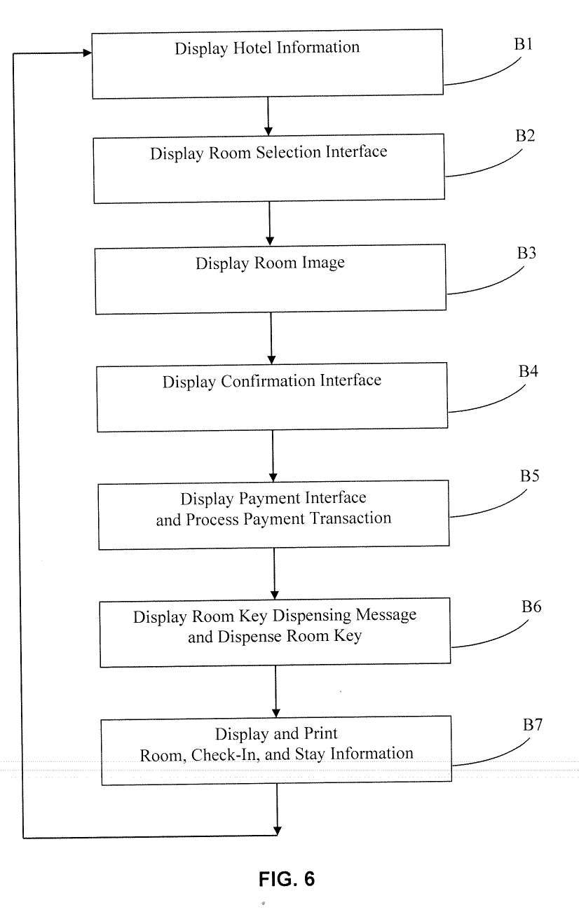

FIG. 6 shows a flow diagram of an exemplary method. Although the method is described according to functions of hotel check-in module 26 of apparatus 100, it will be appreciated that the method is not limited to apparatus 100. The functions described below can be implemented by instructions executed by one or processors of computer 104 and/or computer 120 of apparatus 100. The instructions can be part of software modules described above in connection with FIG. 3.

Apparatus 100 displays hotel information on touch screen 41 (Block B1). Hotel information can be a graphics slide show or animation showing images and text descriptions of the hotel exterior, local and nearby attractions, location and map, room accommodations, amenities, restaurants, bars, meeting facilities, and other services offered by one or more hotels. A touch-sensitive graphical button, for choosing a room, is simultaneously displayed on touch screen 41. Computer 104 detects when a person touches the graphical button and, in response, causes room selection graphical interface to be displayed on touch screen 41 (Block B2).

If the person has made a prior reservation, the person may be prompted on touch screen 41 to enter an identification number, which can be a passport number, social security number, or credit card number. The identification number is one which was previously associated with the prior reservation. Entry of the identification number, made by the person on touch screen 41, initiates the process by which the person checks into the hotel. The identification number is communicated by apparatus 102 to hotel reservation system 105 in order to match the identification number to a prior reservation.

FIG. 7 shows exemplary room selection graphical interface 200 having multiple touch-sensitive graphical buttons that allow a person to specify a desired type of room and other details. Room selection graphical interface 200 has a plurality of touch-sensitive graphical buttons that allow a person to select the floor level on which the room is located, select a room in which smoking is permitted, select a comfort level for the room (such as standard, commercial, or luxury), select or change dates and/or a number of nights the person wishes to occupy the room, and select whether the room receives direct sunlight. There can also be a touch-sensitive graphical button to select or change an occupancy number (such as the number of beds in the room). The touch-sensitive graphical buttons, when touched by a person, result in a touch-sensitive options menu 202. The touch-sensitive graphical buttons and menu allow the person to set parameters for a filter that is applied to hotel room data set. The parameters are, in effect, the person's room selection criteria.

In some embodiments, hotel room data set is obtained by computer 104 from hotel reservation system 105 (FIGS. 1 and 2) before any of Block 1 and Block 2. Hotel room data set includes information for all possible rooms and options. Hotel room data set is stored in database 108. Next, after filter parameters have been set by the person from room selection graphical interface 200, computer 104 applies the filter to hotel room data set to obtain information (e.g., room number, images, price, etc.) about the rooms that meet the filter parameters.

In alternative embodiments, the hotel room data set is not obtained by computer 104 from hotel reservation system 105 or other external system. After filter parameters have been set by the person from room selection graphical interface 200, computer 104 sends the filter parameters to hotel reservation system 105. Hotel reservation system 105 applies the filter to the hotel room data set, then sends to computer 104 only the information (e.g., room number, images, price, etc.) about the rooms that meet the filter parameters.

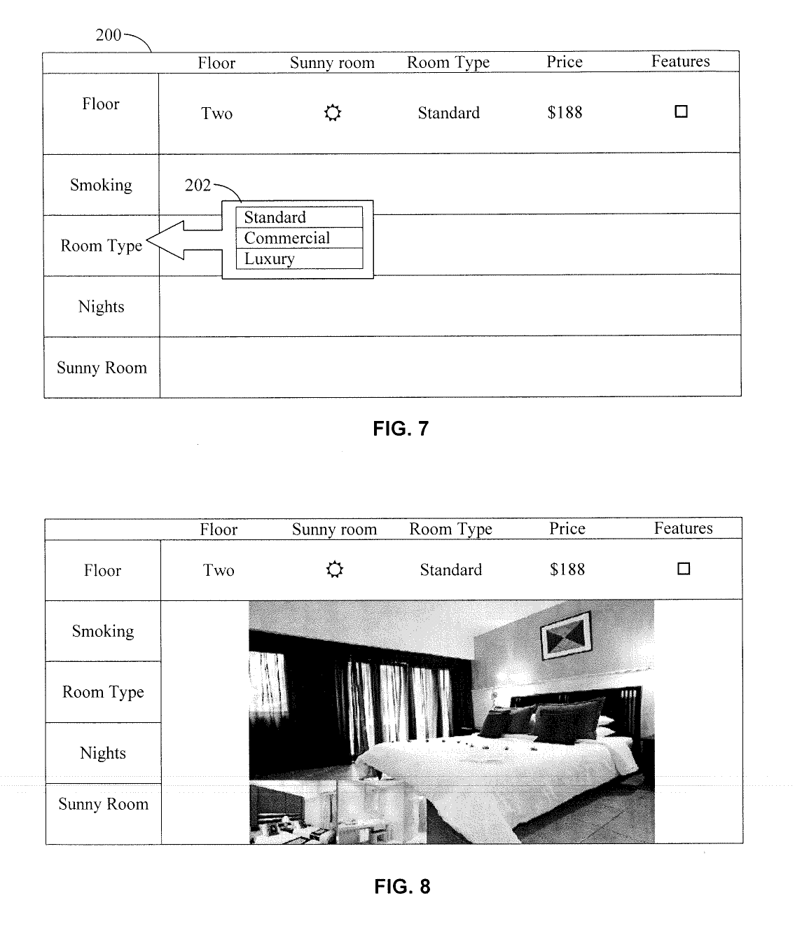

The information about the rooms that meet the filter parameters is displayed on touch screen 41, as shown for example in FIG. 8 (Block B3). If more than one room meets the filter parameters, the person may select a particular room using a touch-sensitive graphical button on touch screen 41.

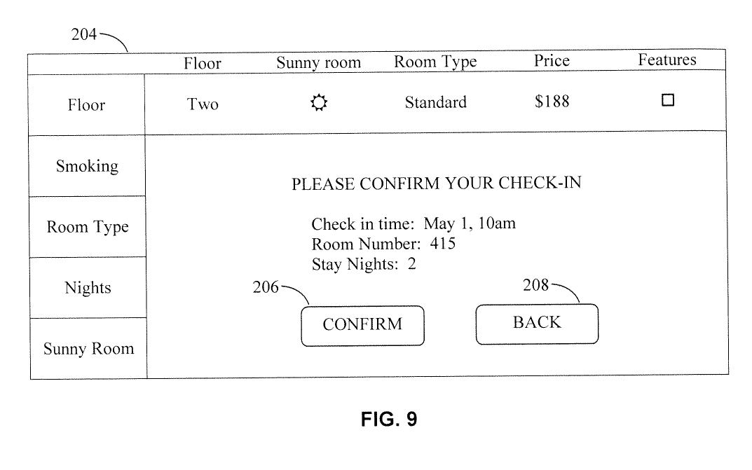

After making the room selection, computer 104 causes a confirmation graphical interface to be displayed on touch screen 41 (Block B4). Exemplary confirmation graphical interface 204 is shown in FIG. 9. Confirmation graphical interface 204 includes touch-sensitive graphical buttons 206, 208 to allow the person to verify or confirm the prior room selection or to go back to Block B2 to change the room selection.

After receiving confirmation from the person of the room selection, computer 104 causes a payment graphical interface to be displayed on touch screen 41 (Block B5) for processing of a payment transaction. Payment graphical interface may include a message for the person to place a payment card or payment device in or adjacent payment card reader 112 (FIGS. 1 and 2) to allow data to be obtained from the payment card/payment device, and may include touch-sensitive graphical buttons to allow the person to enter a personal identification number (PIN) or other verification code associated with the payment card/payment device.

Based on data obtained from the payment card/payment device and the room selection, computer 104 communicates with payment card transaction system 107 (FIGS. 1 and 2) to initiate or record a payment transaction. In some embodiments, computer 104 does not communicate with payment card transaction system 107 (FIGS. 1 and 2) until after check out. In some embodiments, the payment transaction is not completed until after the check-out.

After processing the payment transaction (which may only be recorded but not completed), computer 104 causes a room key dispensing graphical interface to be displayed on touch screen 41 (Block B6). Room key dispensing graphical interface may include touch-sensitive graphical buttons to allow the person to select the number of keys the person desires and may include a message informing the person to wait to obtain a room key from apparatus 100. Computer 104 also causes room key dispenser 114 (FIGS. 1 and 2) to select and eject a room key from the plurality of room keys stored in room key dispenser 114. Before the room key is ejected, room key dispenser 114 may activate a room key. Room key activation may include sending a room key serial number to hotel reservation system 105 and/or programming the room key with a code obtained from hotel reservation system 105.

After the room key is dispensed, computer 104 causes information to be displayed on touch screen 41 and printed out of receipt dispenser 116 (Block B7). The information may include any combination of the hotel address, map, room number, dates and times for room check in and check out, and telephone number for assistance.

In alternative embodiments, apparatus 102 does not include a payment card reader. A payment module is stored in a non-volatile component of database 108. The payment module includes instructions executable by one or more processors of computer 104 which causes a payment graphical interface to be displayed on touch screen 41. The payment graphical interface prompts a person to enter payment information, such as a credit card number, debit card number, PIN, other codes, and/or billing information used for payment which are transmitted to an external system, such as payment card transaction system 107.

In alternative embodiments, user interface 110 includes a display screen and keyboard and/or touch pad located outside of the display area of the display screen. The touch-sensitive graphical buttons described above are replaced by pushbuttons on the keyboard.

While several particular forms of the invention have been illustrated and described, it will also be apparent that various modifications can be made without departing from the scope of the invention. It is also contemplated that various combinations or subcombinations of the specific features and aspects of the disclosed embodiments can be combined with or substituted for one another in order to form varying modes of the invention. Accordingly, it is not intended that the invention be limited, except as by the appended claims.

What is claimed is:

1. An apparatus for hotel room selection and check in, comprising:
a database;
a user interface including a display screen;
a room key dispenser; and
at least one computer processor configured to execute instructions stored in database for controlling the user interface and the room key dispenser.

2. The apparatus of claim 1, wherein the database stores images and descriptions of a hotel or parts of a hotel.

3. The apparatus of claim 1, wherein the database stores information on room availability and room rates of one or more hotels.

4. The apparatus of claim 3, wherein the database stores a hotel reservation system module executable by the at least one computer processor for obtaining the information on room availability and room rates from an external system.

5. The apparatus of claim 1, wherein the database stores instructions executable by the at least one computer processor for setting filter parameters for hotel room selection.

6. The apparatus of claim 5, wherein the display screen is a touch screen controlled by the at least one computer processor to display touch-sensitive graphical buttons for setting the filter parameters.

7. The apparatus of claim 5, wherein the instructions are executable by the at least one computer processor for applying the filter parameters to a hotel room data set.

8. The apparatus of claim 5, wherein the instructions are executable by the at least one computer processor for sending the filter parameters to an external system.

9. The apparatus of claim 1, wherein the display screen is a touch screen controlled by the at least one computer processor to display touch-sensitive graphical buttons for room selection.

10. The apparatus of claim 1, further comprising a payment device reader.

11. The apparatus of claim 10, wherein the payment device reader is controlled by the at least one computer processor to obtain data from a payment device.

12. The apparatus of claim 11, wherein the at least one computer processor is configured to execute instructions, stored in the database, to transmit the data obtained from the payment device to an external system.

13. The apparatus of claim 1, wherein the room key dispenser is configured to store a plurality of room keys.

14. The apparatus of claim 1, wherein the room key dispenser is configured to activate a room key.

15. The apparatus of claim 1, wherein the room key dispenser is controlled by the at least one computer processor to obtain a room key serial number from a room key stored within the room key dispenser.

16. The apparatus of claim 15, wherein the at least one computer processor communicates the room key serial number to an external system.

17. The apparatus of claim 1, wherein the room key dispenser is controlled by the at least one computer processor to program a code to a room key stored within the room key dispenser.

18. The apparatus of claim 17, wherein the at least one computer processor obtains the code from an external system.
